(19) United States
(12) Patent Application Publication
(10) Pub. No.: US 2013/0163493 A1
(43) Pub. Date: Jun. 27, 2013

(54) METHOD AND APPARATUS FOR REDUCING POWER CONSUMPTION IN LTE USER EQUIPMENT

(71) Applicant: Samsung Electronics Co., Ltd., Gyeonggi-do (KR)

(72) Inventor: Venkateswara Rao MANEPALLI, Bangalore (IN)

(73) Assignee: Samsung Electronics Co., Ltd., Gyeonggi-do (KR)

(21) Appl. No.: 13/723,745

(22) Filed: Dec. 21, 2012

(30) Foreign Application Priority Data
Dec. 23, 2011 (IN) 4553/CHE/2011

(51) Int. Cl. H04W 52/02

(52) U.S. Cl. CPC H04W 52/0251
USPC 370/311

(57) ABSTRACT

Methods are provided for reducing power consumption in a Long Term Evolution (LTE) User Equipment (UE) by transferring the UE into a power saving mode. The UE determines a data status for applications running on the UE. A Medium Access Control (MAC) indication of the data status of the UE is sent from the UE to at least one network module. The indication is identified at the network module upon receiving the indication. The network module performs an action for the UE that reduces power consumption at the UE.

### PRIORITY

This application claims priority under 35 U.S.C. §119(a) to an Indian Patent Application filed in the Indian Patent Office on Dec. 23, 2011 and assigned Serial No. 4553/CHE/2011, the contents of which are incorporated herein by reference.

### BACKGROUND OF THE INVENTION

1. Field of the Invention

The present invention relates generally to the field of mobile communication, and more particularly, to method and apparatus for reducing power consumption in user equipments.

2. Description of the Related Art

Long Term Evolution (LTE) is a broadband system designed by 3^{rd} Generation Partnership Project (3GPP) supporting packet-based services. In an LTE system, a User Equipment (UE) can exist in two states, an idle state and a connected state. In the idle state, Discontinuous Reception (DRX) allows the UE to switch off its radio receiver and thereby reduce its power consumption. Further, the UE can enter the idle state only upon receiving a Radio Resource Control (RRC) connection release message from the network. In the connected state a UE can be in active data transmission or in a DRX mode. The DRX pattern used by the UE is configured by the network and follows a definite pattern of on and off cycles. DRX can be either a short DRX or a long DRX.

The UE enters the connected mode via a RRC connection setup message and enters the idle mode or leaves the connected mode via a RRC connection release message received from the network. Thus, it is evident that the decision to leave the connected mode, and the configuration of DRX parameters in the connected mode, are provided by the network. Thus, the network will decide when the UE has to go into the idle mode. This leads to power wastage at the UE, because it takes some time for the network to realize that the data transmission is over at the UE and the UE remains in the connected mode.

In LTE systems there is no mechanism in which the UE can communicate to the network that the UE is done with the active data transfer and that the UE does not expect anything in the near future. An LTE UE must obey the network and be in the connected mode with the previously configured DRX parameters for considerably longer duration. If the UE does not enter into the idle mode, the continuous power consumption leads to lower battery level. Specifically, the situation in the UE may not be perceived by the network from the status of data transmissions in currently running applications. It is particularly true that the advent of “always on” applications, active sync applications and push email type of applications, which can figure out the status of the active data activity, will considerably affect UE power consumption. The networks may release the connection at a later point in time. The UE, on which the application is running, would be in a better position to assess the status of data transmission, and hence, can provide an indication to the network if there is going to be any more data activity.

In existing wireless systems, some mechanisms exist for sending an indication to the network about the status of the data transmission at the UE. However, these mechanisms cannot be easily implemented in an LTE system. In addition, these mechanisms require additional network resources. For example, when the UE is in the connected mode, the resources required for communication to the network may not be available, and hence, additional resources will have to be employed. This leads to additional costs. Existing mechanisms do not have means to exploit the available protocols and resources in order to convey the data status to the network.

Due to the aforementioned reasons, it is evident that existing systems do not possess effective mechanisms for the UE to send indications to the network regarding the data transmission status, resulting in power wastage at the UE.

### SUMMARY OF THE INVENTION

The present invention has been made to address at least the above problems and/or disadvantages and to provide at least the advantages described below. Accordingly, an aspect of the present invention provides a method of enabling a UE to send an indication to the network regarding the data transmission status to reduce power consumption.

Another aspect of the present invention provides a method of employing LTE Medium Access Control (MAC) protocol for sending the indication to the network.

According to one aspect of the present invention, there is provided a method for reducing power consumption in an LTE UE by transferring the UE into a power saving mode. The method includes: determining, by the UE, a data status for applications running on the UE; sending a Medium Access Control (MAC) indication of the data status for the applications, from the UE to at least one network module; receiving the MAC indication and identifying the data status of the UE through the MAC indication at the network module; and when the data status of the UE shows that the UE has no more data activity, performing, by the network module, an action for reducing power consumption at the UE.

According to another aspect of the present invention, there is provided a network module for reducing power consumption in an LTE UE. The network module is configured to receive a MAC indication of a data status of the UE; decode the MAC indication to identify a status of a Buffer Status Report (BSR) in the MAC indication; and perform an action for reducing power consumption at the UE when the status of the BSR shows that the UE has no more data activity.

According to a further aspect of the present invention, there is provided a UE configured to reduce power consumption in LTE. The UE is configured to identify a data status for applications; trigger a MAC indication of the data status; and sending the MAC indication of the data status to a network module.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a structure of an LTE network, according to an embodiment of the present invention;

FIG. 2 is a diagram illustrating a configuration of an enhanced Node (eNode) B, according to an embodiment of the present invention;

FIG. 3 is a flowchart illustrating a procedure of sending a status of power consumption at a UE to the eNode B, according to an embodiment of the present invention;

FIG. 4 is a block diagram illustrating different possibilities employed by the eNode B to reduce power consumption, according to embodiments of the present invention; and

FIG. 5 is a sequence diagram illustrating communication between the UE and eNode B, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

Embodiments of the present invention achieve a method for reducing power consumption in a UE in LTE, by sending an indication to the network regarding the status of the data transmission in the UE.

Embodiments of the present invention describe a system and method for reducing power consumption in LTE networks. The UE is configured for sending an indication to the element of the network, i.e., eNode B, regarding the data transmission status at the UE. The indication is sent in the form of a MAC protocol message to the eNode B. Upon receiving the indication, the eNode B decodes the message to determine the BSR in the MAC message. The eNode B then identifies the status of the UE and determines that the UE is no longer involved in data transmission. Thus, the eNode B takes the required action to reduce power consumption at the UE. The required action may include modifying the DRX parameters, releasing the RRC connection, or transferring the UE into the idle state of the DRX, where the power consumed by the UE is minimal. The power consumption of the UE is thus minimized.

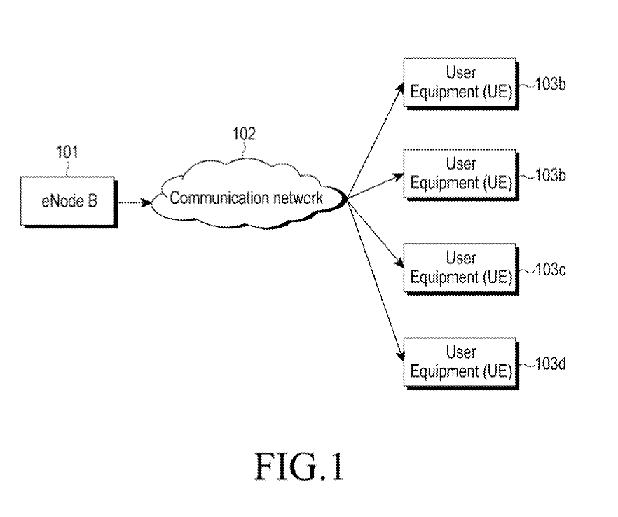

FIG. 1 is a diagram illustrating the LTE network, according to an embodiment of the present invention. The LTE network includes at least one eNode B 101, a communication network 102 and UEs 103a, 103b, 103c and 103d.

The eNode B 101 may be an enhanced Node B that is responsible for transmission of data to and from the UEs 103a-103d. The eNode B 101 is further responsible for allocation of resources to the UEs 103a-103d for data transmission. The eNode B 101 is configured to address the requests received from the UEs 103a-103d for reducing power consumption at the UEs 103a-103d. For example, the eNode B 101 is configured to understand the indication received on the MAC BSR regarding the data status of a corresponding UE. Further, the eNode B 101 takes the required action in order to reduce the power consumption at the corresponding UE.

The communication network 102 provides a means for communication between the UEs 103a-103d and the Node B 101. The MAC messages flow in and through the communication network 102. The communication network 102 may be any wireless network including, for example, networks that comply with the Mobile Worldwide interoperability for Microwave Access (WiMAX) (based on Institute of Electrical and Electronics Engineers (IEEE) 802.16e or IEEE 802.16m), 3GPP LTE, 3^{rd} Generation Partnership Project 2 (3GPP2) Air Interface Evolution (ME), IEEE 802.20 or other wireless network standards. In the network operating environment, a given UE may communicate with the eNode B 101 using the wireless network 102 based on one wireless network standard, while the eNode B 101 may communicate with other UEs using wireless network 102 based on another wireless network standard.

The UEs 103a-103d may be any communication device that is capable of supporting communication with the eNode B 101. The UEs 103a-103d may be embodied as a smart phone, a tablet, a mobile phone, etc.

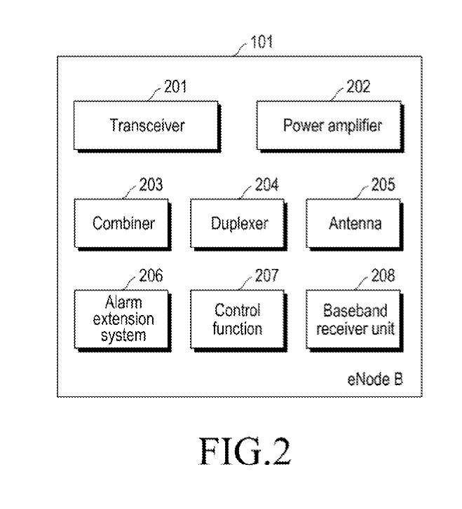

FIG. 2 is diagram illustrating an eNode B, according to an embodiment of the present invention. The eNode B 101, as depicted herein, is responsible for receiving an indication from the UEs 103a-103d on the status of the data transmission activity at the UEs 103a-103d. Upon receiving the status, the eNode B 101 modifies various parameters so as to reduce the power consumption at the UEs 103a-103d. The eNode B 101 includes a transceiver 201, a power amplifier 202, a combiner 203, a duplexer 204, an antenna 205, an alarm extension system 206, a control function 207, and a base band receiver unit 208.

The transceiver 201 may be referred to as the driver receiver. The driver receiver is embodied in the form of a single Transceiver Radio Unit (sTRU), a double Transceiver Radio Unit (dTRU) or a composite Double Radio Unit (DRU). The transceiver 201 transmits and receives signals. The transceiver 201 also sends and receives signals to/from higher network entities, such as the Radio Network Controller (RNC).

The power amplifier 202 amplifies the signal from the DRX for transmission through the antenna 205. The power amplifier 202 may be integrated with the DRX. The combiner 203 combines feeds from several DRXs so that they may be sent out through a single antenna. Also, the combiner 203 allows for a reduction in the number of antenna used.

The duplexer 204 is responsible for separating, sending, and receiving signals to/from the antenna. The duplexer 204 performs sending and receiving of signals through the same antenna ports (cables to antenna).

The antenna 205 provides a means for transmitting and receiving information. The alarm extension system 206 collects working status alarms of various units in the eNode B 101, and extends the alarms to Operations and Maintenance monitoring stations.

The control function 207 controls and manages the various units of the eNode B 101 including, for example, any existing software. On-the-spot configurations, status changes, and software upgrades are performed through the control function 207. The baseband receiver unit 208 receives, for example, frequency hopping, a Digital Signal Processing (DSP) signal, etc.

In an embodiment of the present invention, the eNode B 101 may be employed in the LTE network. Further, the eNode B 101 may be referred to as a network module, a Base Station and the like.

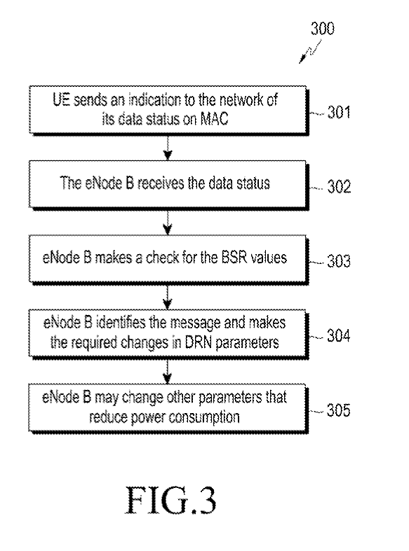

FIG. 3 is a flowchart illustrating a method of communicating the status of the UE to the eNode B for power consumption, according to an embodiment of the present invention. When a UE is in the RRC connected mode it continues to transfer data or perform any other data activity until the data activity is over. In an embodiment of the present invention, the data activity may be, for example, sync, application usage, and so on. Once the data activity process is over and there is no more data for transfer, the UE sends an indication to the network regarding the status, in step 301. The indication is sent to the eNode B 101 via a MAC Control Element (CE) for BSR. A central coordination entity in the UE that coordinates all the applications provides a request to the MAC entity in the LTE UE to trigger the sending of a BSR MAC CE to the network. This BSR MAC CE needs to be treated as a special trigger and as a regular BSR, so that a Scheduling Request (SR) is triggered if an Uplink Physical Uplink Shared Channel (UL) (PUSCH) is not available, so as to transmit the BSR. The BSR is filled with zeros, or is said to be empty, so that this is a special case and the eNode B 101 recognizes that the UE has ‘no more data activity’. In an embodiment of the present invention, the BSR may be a short BSR or long BSR.

The eNode B 101 receives the BSR message, in step 302. The eNode B 101 decodes the BSR and identifies that the message is for ‘no more data activity’ on the corresponding UE, in step 303. The eNode B 101 then makes the required change in DRX parameters for reducing the power consumption, in step 304. In an embodiment of the present invention, the change may be a release of the RRC connection or a modification of the DRX parameters in UE, such as, modifying an onDurationTimer, a long DRX-Cycle and overriding the inactivity timer by moving the UE to the DRX mode. The eNode B 101 may also command the UE 103 to move to long DRX instantaneously, even if the short DRX is configured. This indication can be interpreted as a UE triggered DRX command in UE in parallel to the network requested DRX command in the DL. Further, the eNode B 101 may also take required actions to reduce the power consumption for the corresponding UE, in step 305. In an embodiment of the present invention, the actions may be to reconfigure and release some of the parameters related to a Physical Uplink Control Channel (PUCCH), a Sounding Reference Signal (SRS), and so on. The various steps in method 300 may be performed in the order presented, in a different order, or simultaneously. Further, in some embodiments of the present invention, some steps provided in FIG. 3 may be omitted.

In an embodiment of the present invention, when BSR reports “no more data activity”, a long BSR may be triggered so that the network can uniquely differentiate if the BSR is normal or special for the case of “no more data activity”. All Logical Control Groups (LCGs) will be carrying ‘zero’ values.

In another embodiment of the present invention, the UE may employ a short BSR for the case of ‘no more data activity”. The eNode B 101 may identify if the BSR is normal or for “no more data activity” through the following sequence of events. An SR is followed by a MAC PDU having only the short BSR with ‘zero’ values in the UL PUSCH provided, and a MAC PDU is received having only the short BSR with ‘zero” values.

In another embodiment of the present invention, the indication of ‘no more data activity” can be based on a pre-defined duration when there is no more data in the UL queues in UE for all of the data logical channels. In another embodiment, the trigger for the above indication can be based on the periodic BSR trigger, but it is limited to the first periodic trigger after the data activity being halted in the UE, and the number of such triggers is limited to a few, and preferably one, so as to avoid excess SR requests for transmission of the ‘zero’ BSR.

In an embodiment of the present invention, upon reception of the above indication ‘no more data activity” from the UE, the eNode B 101 may release the RRC connection or modify the DRX parameters for the UE. The modification may include modifying the onDurationTimer, longDRX-Cycle and overriding the inactivity timer by moving the UE to DRX mode. Also, eNode B 101 may command the UE to move to a long DRX instantaneously, even if the short DRX is configured. This indication can be interpreted as a UE triggered DRX command in UE in parallel to the network requested DRX command in the DL. With the above indications, the network can identify when the UE triggers an indication for ‘no more data activity“, and as a response, the network may perform a set of actions either to release the RRC connection or to modify the DRX parameters, which require some signaling.

In an embodiment of the present invention, the UE may maintain a pre defined configuration provided by the network for DRX parameters, PUCCH and SRS. With an agreement between the UE and network, the UE can activate those parameters at the reception of the indication for ‘no more data activity” by the network and at the reception of an acknowledgement of the BSR MAC CE command by the UE.

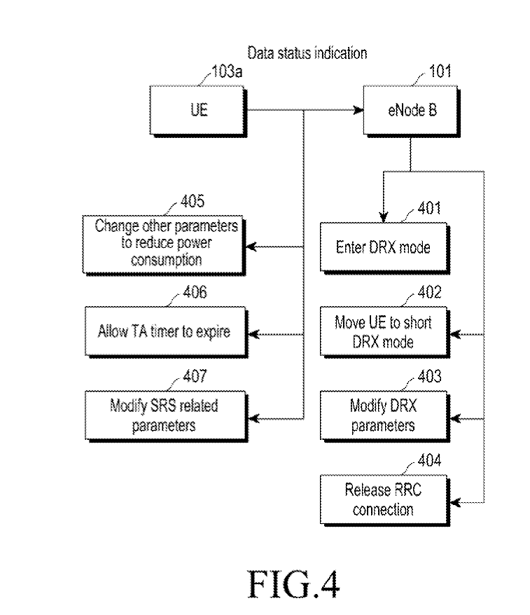

FIG. 4 is a block diagram illustrating different possibilities employed by the eNode B to reduce power consumption, according to an embodiment of the present invention. The UE 103a runs applications that can determine the data transmission activity, and all such applications are coordinated internally in the LTE UE 103a. The LTE UE 103a can detect and determine that all the applications are done with the active data transmission, can trigger an indication to the network, and can request the network to reduce battery consumption. Based on the indication from the UE 103a, the eNode B 101 can take one or more of the following actions to reduce power consumption. The eNode B 101 can immediately enter the UE 103a into DRX mode, in step 401. The eNode B 101 may move the UE 103a to long DRX and immediate override the short DRX, in step 402. The eNode B 101 may modify the DRX parameters, in step 403. The eNode B 101 may release the RRC Connection, in step 404. The eNode B 101 may change any of the other parameters that can reduce the battery consumption, in step 405. The eNode B 101 may not update the TA timer and allow it to expire, in step 406. The eNode B 101 may release or modify the SRS related parameters, in step 407. By performing one or more of previous steps the power consumption of the UE 103a may be reduced.

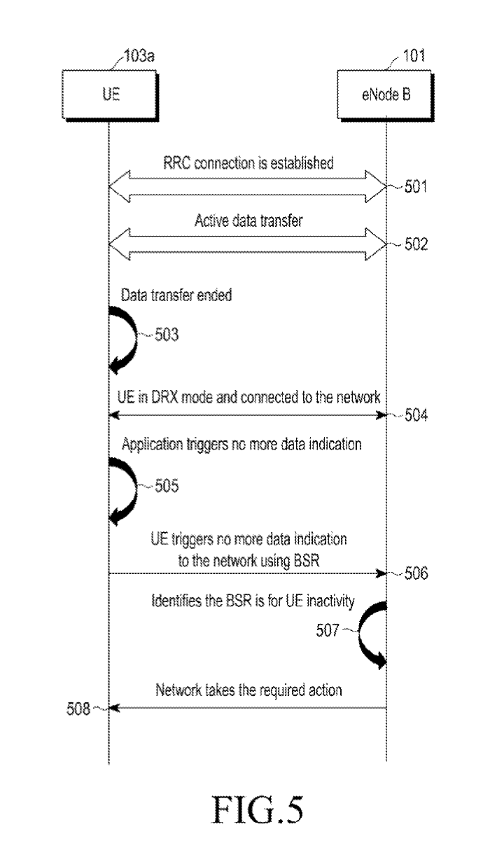

FIG. 5 is a sequence diagram illustrating communication between the UE and eNode B, according to an embodiment of the present invention. When the UE 103a has data activity, a RRC connection is established, in step 501. Active data transmission or reception is continuous, in step 502. Once the data activity on the UE 103a ends, in step 503, the UE 103a determines an indication of the statuses of the applications on the UE 103a. When the UE 103a determines that there is no more data activity in the near future, the UE 103a enters into the DRX mode and still remains in the connected state to the network (eNode B), in step 504. This may result in power loss at the UE 103a.

The power consumption may be reduced by sending an indication from the UE 103a to the eNode B 101, since the applications running on the UE 103a are in a better position to decide when there is no more data activity and the UE may go into a power saving mode. The applications on the UE 103a trigger no more data activity, in step 505. This may be performed by the application coordinator on the UE 103a by sending the indication in a BSR message using MAC. Further, this indication is sent to the eNode B 101, in step 506. The eNode B 101, upon receiving the indication identifies the message and determines the no more activity state for the UE 103a, in step 507. The eNode B 101 then takes the necessary action so as to reduce the power consumption in the UE 103a, in step 508. The action may be to either release the RRC connection or to modify the DRX parameters. The UE 103a may be put into a short DRX mode, a long DXR mode, etc., to further reduce the power consumption. The various steps in the method of FIG. 5 may be performed in the order presented, in a different order or simultaneously. Further, in some embodiments of the present invention, some steps listed in FIG. 5 may be omitted.

The embodiments of the present invention described herein can be implemented through at least one software program running on at least one hardware device, and performing network management functions to control the elements. The elements shown in FIGS. 1 and 2 include blocks that can be at least one of a hardware device, or a combination of a hardware device and a software module.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for reducing power consumption in a User Equipment (UE), the method comprising:
determining, by the UE, a data status for applications running on the UE;
sending a Medium Access Control (MAC) indication of the data status for the applications, from the UE to at least one network module;
receiving the MAC indication and identifying the data status of the UE through the MAC indication at the network module; and
when the data status of the UE shows that the UE has no more data activity, performing, by the network module, an action for reducing power consumption at the UE.

2. The method of claim 1, wherein determining the data status comprises:
checking if data transfer, data update, and data reception are over at the UE; and
when data transfer, data update, and data reception are not over at the UE, checking for an indication of no more data activity.

3. The method of claim 1, wherein sending the MAC indication comprises sending an indication of the data status to the network module through a Buffer Status Report (BSR) MAC Control Element (CE), wherein the BSR is filled with zeros to indicate that the UE has no more activity, and the BSR is one of a short BSR and a long BSR.

4. The method of claim 3, wherein the BSR is treated as a special trigger by the UE and the network module, and the BSR is treated as a regular BSR by the UE so that a Scheduling Request (SR) is triggered when a Physical Uplink Shared Channel (PUSCH) is not available so as to transmit the BSR.

5. The method of claim 1, wherein identifying the data status comprises reading a zero status of the BSR MAC CE to determine that there is no more data activity at the UE.

6. The method of claim 1, wherein performing the action comprises releasing a Radio Resource Connection (RRC) connection.

7. The method of claim 1, wherein performing the action comprises modifying Discontinuous Reception (DRX) parameters.

8. The method of claim 1, wherein the indication is based on a pre-defined duration during which there is no more data in uplink queues of the UE for all data logical channels, or is based on periodic triggers from the UE.

9. The method of claim 1, wherein the network module is an enhanced Node B.

10. A network module for reducing power consumption in a User Equipment (UE), the network module being configured to:
receive a Medium Access Control (MAC) indication of a data status of the UE from the UE;
decode the MAC indication to identify a status of a Buffer Status Report (BSR) in the MAC indication; and
perform an action for reducing power consumption at the UE when the status of the BSR shows that the UE has no more data activity.

11. The network module of claim 10, wherein the MAC indication is triggered by a coordination entity residing within the UE.

12. The network module of claim 10, wherein the BSR comprises zeros to indicate that there is no more data activity associated with the UE, and is one of a short BSR and a long BSR.

13. The network module of claim 10, wherein the network module performs the action by releasing a Radio Resource Connection (RRC) connection.

14. The network module of claim 10, wherein the network module performs the action by modifying Discontinuous Reception (DRX) parameters.

15. The network module of claim 10, wherein the network module is an enhanced Node B.

16. The network module of claim 10, wherein the network module further reconfigures and releases parameters related to a Physical Uplink Control Channel (PUCCH) and a Sounding Reference Signal (SRS) upon receiving the MAC indication.

17. A User Equipment (UE) for reducing power consumption, the UE being configured to:
identify a data status for applications
trigger a Medium Access Control (MAC) indication of the data status; and
send the MAC indication of the data status to a network module.

18. The UE of claim 17, wherein the UE identifies the data status by checking if data transfer, data reception, and data update are over at the UE and triggering an indication of no more data activity at the UE through a MAC Control Element (CE) Sounding Reference Signal (SRS) by a coordination entity of the UE when data transfer, data reception, and data update are not over at the UE.

19. The UE of claim 17, wherein the network module is an enhanced Node B, and the UE is one of a mobile phone, a tablet, and a smart phone.

20. The UE of claim 17, wherein the UE maintains a pre-configuration provided by a network for at least one of: Discontinuous Reception (DRX) parameters, a Physical Uplink Control Channel (PUCCH), and a Sounding Reference Signal (SRS), and the UE can activate the parameters upon obtaining the indication by the network and at the reception of an acknowledgement of the Buffer Status Report (BSR) MAC CE command.
